(19) United States
(12) Patent Application Publication
(10) Pub. No.: US 2022/0219101 A1
(43) Pub. Date: Jul. 14, 2022

(54) VERTICAL SCREW SCREEN WITH OPTIMIZED TRANSPORT FEATURES

(71) Applicant: Sulzer Management AG, Winterthur (CH)

(72) Inventors: Robert SABOL, Orange, CA (US); Corey GLAUBERMAN, Tustin, CA (US); Todd NYDAM, Newport Beach, CA (US); Kevin MOIR, Capistrano Beach, CA (US); Rory E. RUSSO, Sandy Springs, GA (US)

(73) Assignee: Sulzer Management AG, Winterthur (CH)

(21) Appl. No.: 17/647,249

(22) Filed: Jan. 6, 2022

Related U.S. Application Data
(60) Provisional application No. 63/135,098, filed on Jan. 8, 2021.

(51) Int. Cl. B01D 29/94; B65G 33/14; B01D 29/35; B65G 33/26

(52) U.S. Cl. CPC B01D 29/94; B65G 33/14; B65G 2812/0577; B65G 33/26; B01D 2201/287; B01D 29/35

(57) ABSTRACT

Aspects of the disclosure provide a screw conveyor for discharging solids from a solid/liquid waste stream is provided and comprises a cylindrically shaped screen segment including perforated screen segments and an inlet for receiving a stream including solid and liquid materials, the perforated portions configured to permit liquids and smaller materials to pass therethrough. The conveyor includes a rotor auger disposed within the screen segment and includes helical flights configured to move solid materials larger than perforations on the perforated screen to move vertically when rotated. A drive motor is included to rotate the rotor auger and anti-rotation elements are disposed radially outward between adjacent perforated screen segments and configured to prevent rotation of solid materials to permit the rotor auger to move the solid materials in an axial direction of the rotor auger rotation.

### CROSS-REFERENCE TO RELATED APPLICATIONS

This application claims the benefit of priority from Provisional Application No. 63/135,098 filed Jan. 8, 2021, the entire contents of which are incorporated herein by reference.

### BACKGROUND

### Field of the Invention

Pump, or lift, stations are required in municipal wastewater collection systems where the wastewater flow must be transported over long distances to the treatment facility and the terrain does not allow for adequate flow by gravity alone. The pump station pushes or raises the wastewater to a higher elevation where it is released and continues its journey by gravity to the treatment facility. Depending on the distances and terrain, multiple lift stations may be installed.

Wastewater is typically comprised of water and soluble organics, including human waste. However, it often contains non-soluble items such as: rags, shoes, articles of clothing, condoms, chunks of asphalt, bits of wood, money, wipes, rocks and many other items that are often flushed down the toilet or introduced into the sewer by industry and the general public. While lift station pumps can more easily pass the soluble organics, blockages occur when non-soluble materials are too large to pass through pump orifices. This behavior is often referred to as pump “ragging”. Once clogged, pump de-ragging is a costly, labor-intensive and hazardous process. When those costs become significant, municipalities tend to employ either solids reduction and/or solids removal equipment to ensure the pump operates efficiently and without disruption. This equipment also increases operational costs.

### Description of the Related Art

In the wastewater solids removal arena, screw conveyors fitted with cylindrical, perforated screens may be employed to screen non-soluble solids (screenings) from the wastewater. One embodiment of this equipment consists of a vertically oriented screw conveyor, installed in a wall-mounted frame at the lower end, receiving wastewater directly from the wet well influent pipe. The bottom, or tail, end conveyor casing is made from cylindrically formed sheet metal with perforations of a size suitable to permit the water and organics to pass, while capturing screenings larger than the perforation diameter. Common perforation diameter sizes include: 2 mm ( 5/64″), 3 mm (⅛″), 6 mm (¼″) and 8 mm ( 5/16″). The perforated screen typically includes a solid bottom plate that keeps the wastewater from flowing unencumbered through the tail end of the conveyor. The conveyor rotor may include a center pipe to inhibit the fallback of material down the center of the spiral, and the outer edge of the spiral in the area of the perforated screen is commonly fitted with a coil-wound or sectional disk-style bristle brush, selected to contact the inner surface of the screen. An inlet port is incorporated into the cylindrical screen, either at the tail end of the conveyor, or at some point along the vertical length of the screen. The inlet port is connected to the wall-mounted frame in such a manner as to cause the wastewater to flow directly from the frame into the cylindrical screen. A high-pressure water distribution manifold with spray nozzles may be mounted vertically, adjacent to the perforated screen, and oriented such that the direction of the water spray is opposite to the tangential direction of travel of the screenings being carried by the rotor. The function of this spray system is to promote cleaning, as well as upward transport of the screenings. Cylindrical conveyor casings above the screen segment are typically formed from unperforated sheet metal and include one or more vertically oriented, anti-rotation bars on the inner surface to provide resistance against the material being transported. The upper-most casing includes a discharge port suitable to permit the transported screenings to exit the vertical conveyor and pass through a chute into a collection container.

In operation, the vertical conveyor is typically at rest in a de-energized state. Wastewater flows from the wet well influent pipe through the wall-mounted frame and into the screen segment of the conveyor. The wastewater impinges on, and flows down, the upper surface of the spiral rotor, as well as up against the perforated screen. While the water and soft organics typically flow through the perforations, some portion of the screenings are trapped by the screen. As the perforations become blinded, the wastewater level inside the screen segment rises. As the level rises sufficiently in the screen segment, the liquid level will also rise in the wall-mounted frame. This level is monitored by a level probe. When the level in the frame reaches a threshold level, denoted by a setpoint in the control system, the motor controller energizes the spiral rotor motor in accordance with predetermined operating parameters. The action of energizing the rotor causes the brush on the outer edge of the rotor to sweep the screen, unblinding the perforations and allowing water to once again pass. This flow of water through the perforations carries screenings, suspended in the wastewater, to the screen, effectively pinning the screenings against the inner surface of the screen. As this occurs, the upper surface of the spiral rotor contacts the pinned screenings and slides beneath them, imparting an upward motion to the screenings. For transport to occur in a screw conveyor, there must be greater friction between the material and the casing than between the material and the rotor. As the screenings move upward, they are transferred into the transport casings FIG. 2 and eventually the discharge casing. The anti-rotation bars in these casings provide edges against which the screenings, now thrust against the inner surface of the casings by centrifugal force, can travel upward and not merely rotate in synchronization with the spiral rotor.

Unfortunately, the behavior of the material in the screen segment of the vertical conveyor is not expressly predictable. The inside surface of the perforated screen is typically very smooth, and, when wetted, the friction between the material and the screen can be lower than the friction between the material and the rotor. This results in material resting on the upper surface of the rotor and rotating around at one elevation. The material may even slide down the upper surface of the rotor to the bottom of the screen segment and collect at the tail end of the screw conveyor. Given its density, grit may also collect at the bottom of the screen segment. As material collects in this area, it may impose radial loads on the spiral rotor that may cause the brush to wear excessively and/or in an eccentric manner. Such wear may allow contact between the spiral and the perforated screen, resulting in further wear and damage to the equipment. The overall result is a vertical conveyor system that may not consistently clear material from the screen segment and may wear the brush, rotor and screen prematurely.

The key issues with the behavior in the screen segment may be divided into the following three areas: (i) vertical transport; (ii) material collection at the bottom of the screen segment, and; (iii) excessive brush wear.

### Vertical Transport

Unlike the profile of the inner surface of the transport and discharge segments, which are fashioned with vertically oriented anti-rotation bars to provide resistance against the material being transported, the inner surface of the perforated screen is, effectively, completely smooth. The preferred orientation of the perforated metal sheet used to fabricate the cylindrical screen is with the punch direction from the inside to the outside of the screen. The benefit to this is that it minimizes brush wear that would otherwise result from the brush passing across the “die” side of the perforated sheet, the side with the most prominent sharp edges.

The smooth nature of the inner surface of the cylindrical screen works against the premise that the friction between the material and the casing (screen) must be greater than the friction between the material and the rotor, for transport to occur. When the rotor is energized and the brush begins sweeping the screen, the material may tend to remain on the upper surface of the spiral at the elevation it was swept from the screen, or worse, the material is washed down the upper surface of the spiral. The result is unpredictable transport of material in this area of the screw conveyor.

### Material Collection at Bottom of Screen Segment

A knock-on effect of unpredictable material transport is that the material may be washed down the spiral until it reaches the bottom of the screen segment, resting on the upper surface of the bottom plate. As a result of the necessary clearance between the tail end of the rotor and the bottom plate, screenings and grit can build into a layer on top of the bottom plate. The screenings may “staple” over the leading edge of the spiral, and the grit may behave as an abrasive material, both acting to damage to the screen basket.

### Excessive Brush Wear

A further effect of the unpredictable material transport and the collection of material at the bottom of the screen segment is that the material can pack and impose radial, or side, loads on the rotor. These side load loads tend to result in eccentric wear of the brush. When the brush wears excessively, the outer circumferential surface of the spiral can contact the perforated screen. Wear of the perforated screen and the rotor can result in costly repairs of the equipment.

### SUMMARY OF EMBODIMENTS

Aspects of the present disclosure are related to a system for capturing and transporting wastewater screenings vertically out of a lift station wet well.

When the inner surface of the cylindrical, perforated screen is smooth, material transport may be unpredictable, potentially resulting in damage to the screen basket, rotor and brush. By incorporating one or more vertical anti-rotation channels into the cylindrical perforated screen, edges are introduced that provide rotational resistance against the screenings. This resistance promotes transport of the material in the direction of the conveyor discharge. As material collects in the channel, the collected solids create additional friction further preventing the solids from rotating with the screw and allowing the lifting action of the helix to take hold and transport the solids with greater predictability and rapidity. While the anti-rotation bars in the transport and discharge segments of the conveyor are raised from the inner surface of the casings, the anti-rotation channels in the screen segment are formed “in counter-relief” (protruding outward from the centerline of the cylindrical screen). This allows for a nominally continuous profile of the inner surface of the screen, eliminating the excessive brush wear associated with attaching “in relief” (protruding inward from the centerline of the cylindrical screen) elements added to the inner surface of the screen.

In order to reduce or eliminate the collection of material at the bottom of the screen segment, an adjustable shoe, or scraper, is attached to the leading edge of the spiral portion of the rotor. This shoe is adjusted to minimize the clearance between the bottom of the rotor and the bottom plate, effectively scraping or shoveling screenings and grit from the bottom plate onto the upper surface of the spiral. Once loaded onto the rotor, the vertical anti-rotation channels play a role in promoting transport of the offending screenings and grit in the direction of the screw conveyor discharge. The shoe is also designed with a stop feature to inhibit, during non-operational periods, solids from following the path down the upper surface of the spiral down onto the bottom plate.

In order to counter the effect of radial, or side, loads at the bottom of the rotor, a corrosion and wear-resistant centering bushing is attached to top surface of the bottom plate at the center point of the circle formed by the cylindrical screen. The tail end of the rotor center pipe fits over the centering bushing. The diameter of the bushing is selected such that there is minimal clearance between the outer circumferential surface of the bushing and the inner surface of the center pipe. The inclusion of the centering bushing permits radial loads on the rotor to be passed directly into the structural elements of the conveyor casings, and not through the coil-wound, or disk-style, bristle brush attached to the outer edge of the spiral in the area of the perforated screen. This acts to reduce or eliminate excessive brush wear that may result in costly damage to the rotor and screen basket.

According to one aspect of the disclosure, a screw conveyor for discharging solids from a solid/liquid waste stream is provided and comprises a cylindrically shaped screen segment including perforated screen segments and an inlet for receiving a stream including solid and liquid materials, the perforated portions configured to permit liquids and smaller materials to pass therethrough; a rotor auger disposed within the screen segment including helical flights configured to move solid materials larger than perforations on the perforated screen to move vertically when rotated; a drive motor to rotate the rotor auger; anti-rotation elements disposed radially outward between adjacent perforated screen segments configured to prevent rotation of solid materials to permit the rotor auger to move the solid materials in an axial direction of the rotor auger rotation.

According to another aspect, the anti-rotation elements are U-shaped channels open toward the rotor auger.

According to another aspect, innermost portions of the anti-rotation elements in the radial direction do not extend inward of the perforated screen segments.

According to another aspect, the screw conveyor may include a rotor shoe at a lowermost portion of the helical flights and at and end of the helical flights of the rotor auger that extends axially upward from the helical flights. The rotor shoe may have a triangular cross section to taper at a thinnest portion on an edge opposite to where the rotor shoe is attached to the helical flights. The rotor shoe may be adjustably attached to the end of the helical flights. Additionally, a side of the rotor shoe attached to the end of the helical flights may protrude above an upper surface of the helical flights.

According to another aspect, the screw conveyor may include a center pipe that extends axially through the center of the rotor auger and forms an open portion within a lower most end of the center pipe; a bottom plate attached to the bottom of the cylindrical shaped screen segment; and a bushing configured to fit within the center pipe that is attached to the bottom plate.

### BRIEF DESCRIPTIONS OF THE DRAWINGS

FIG. 1 is a perspective view illustrating a screw conveyor system in accord with the present disclosure and installed in a wastewater wet well;

FIG. 2 is a perspective view illustrating various structures of a lower portion of the screw conveyor system;

FIG. 3 is a perspective view of a perforated screen including structural elements;

FIG. 4 is a perspective view of a perforated screen segment with the perforated screen removed to show internal features;

FIG. 5 is a perspective view of a perforated screen including anti-rotation channels;

FIG. 6 is a perspective view of a perforated screen including anti-rotation channels with the perforated screen removed to show internal features including a rotor shoe;

FIG. 7 is another perspective view of the perforated screen segment;

FIG. 8 is a cross-sectional view of a perforated screen taken along an axial centerline to show a center pipe and bushing features;

FIG. 9 is a perspective lower view of a perforated screen including anti-rotation channels with the perforated screen removed to show internal features including a rotor shoe;

FIG. 10 is a perspective lower view of a perforated screen including anti-rotation channels with the perforated screen removed to show internal features including a rotor shoe;

FIGS. 11-13 show variations of a perforated screen that is included and which includes anti-rotation bars.

### DETAILED DESCRIPTION

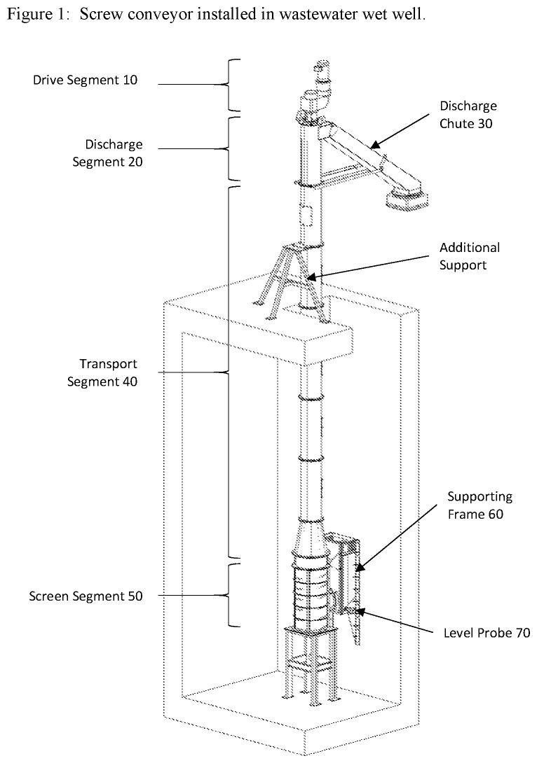

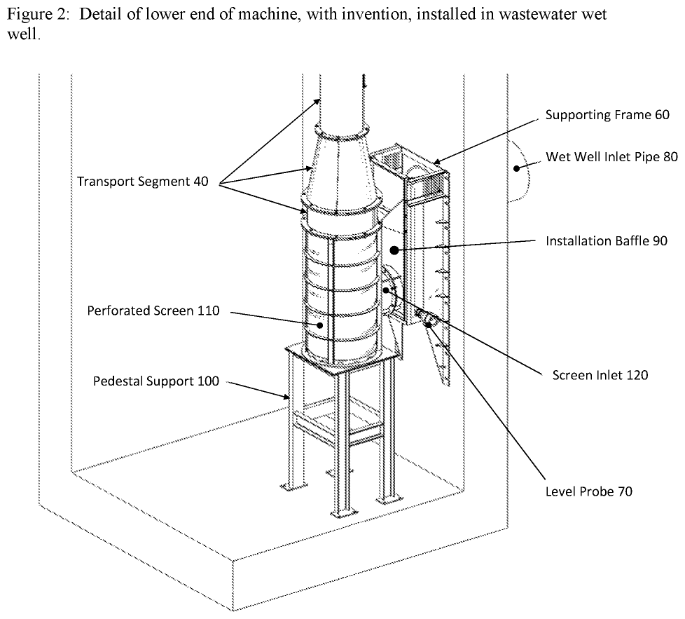

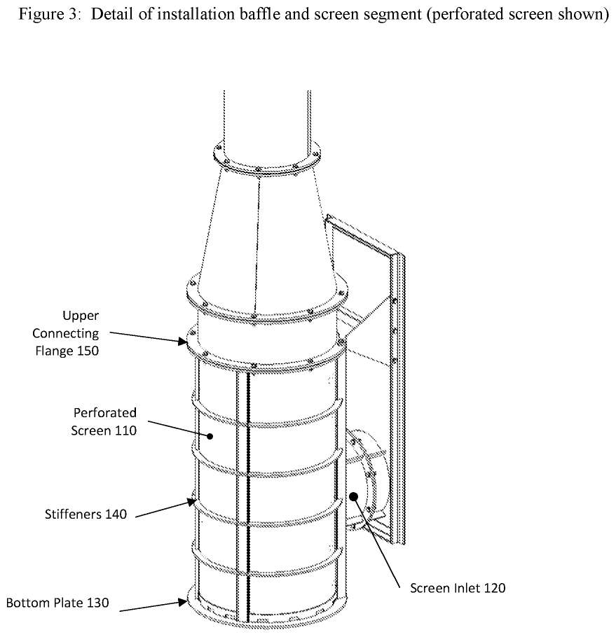

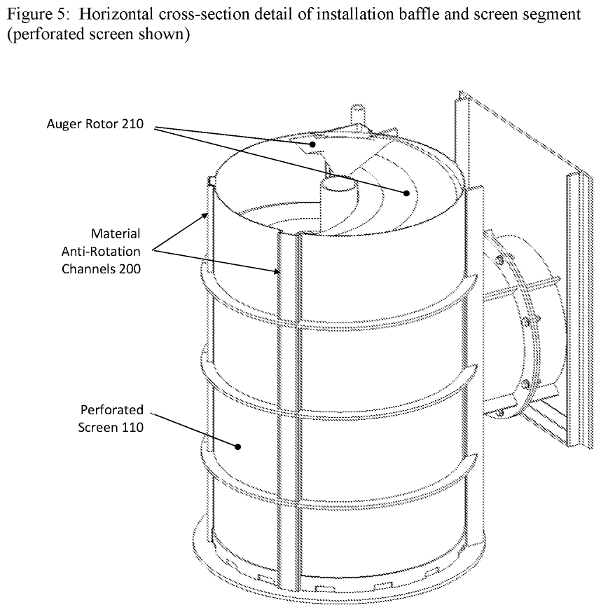

In one embodiment of the disclosure as shown in FIG. 1, a vertically oriented screw conveyor is mounted in a supporting frame 60, which is in turn fastened to the inner wall of a wet well over a wet well inlet pipe 80 (see FIG. 2). A level probe 70 is mounted either above or on the side of the supporting frame 60. The screw conveyor consists of a screen segment 50, a transport segment 40, discharge segment 20 and drive segment 10. The screen segment is connected to the supporting frame 60 by an installation baffle 90 (see FIG. 2). The screen segment 50 may sit a-top a pedestal support 100 (see FIG. 2). Additional supports may be used to connect the transport segment 40 of the screw conveyor to some portion of the wet well (FIG. 1). A discharge chute 30 is attached to the outlet of the discharge segment 20 and may be supported by chute supports. The drive segment 10, including a speed reducer, drive motor, and shaft seal, is connected to the top end of the rotor contained within the casings of the discharge, transport and screen segments. As shown in FIGS. 3-5, the screen segment 50 may include rolled, perforated, sheet metal screen 110 (FIG. 3), an upper connecting flange 150, a bottom plate 130, an inlet pipe 120, horizontal & vertical stiffeners 140 and a spray water manifold.

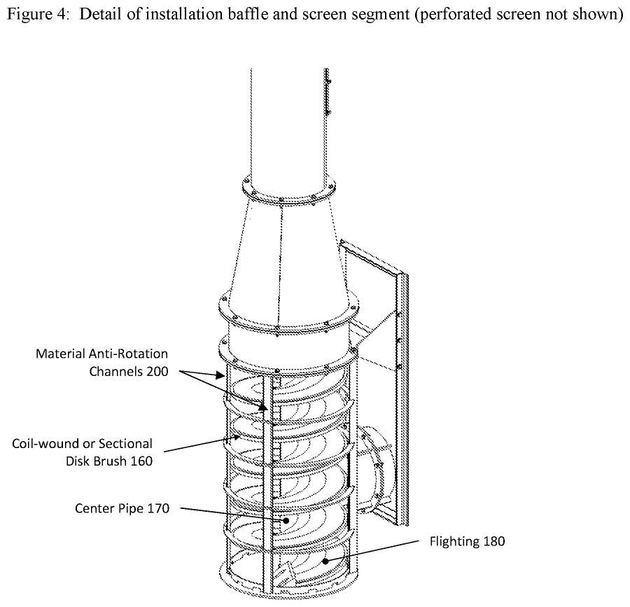

The rotor extending from the screen segment 50 through the discharge segment 20 may include: spiral, or sectional flighting 180, a center pipe 170 or torque tube, a drive shaft and, one or more discharge paddles. The rotor is driven by the drive segment 10 and may include a coil-wound, or sectional disk brush 160 that is affixed to the top, bottom or outer circumferential surface of the spiral in the area of the perforated screen 110 (FIG. 4) and contacts the inner surface of the screen 110. The spiral or sectional flighting functions to move solids upward through the perforated screen segment 50 to the transport segment 40, and eventually upward to the discharge chute 30.

To prevent solid materials such as rags from merely rotating with the rotor auger 210, the perforated screen 110 includes one or more U-shaped, material anti-rotation channels 200 (FIG. 4, 5, 6, 7) that are oriented axially to the centerline of the screen segment 50 and welded in between adjacent sections of rolled perforated screen section forming the perforated screen segment 50. The web of each anti-rotation channel protrudes radially outward from the perforated screen to form channels “in counter relief” to the inner surface of the perforated screen segment 50.

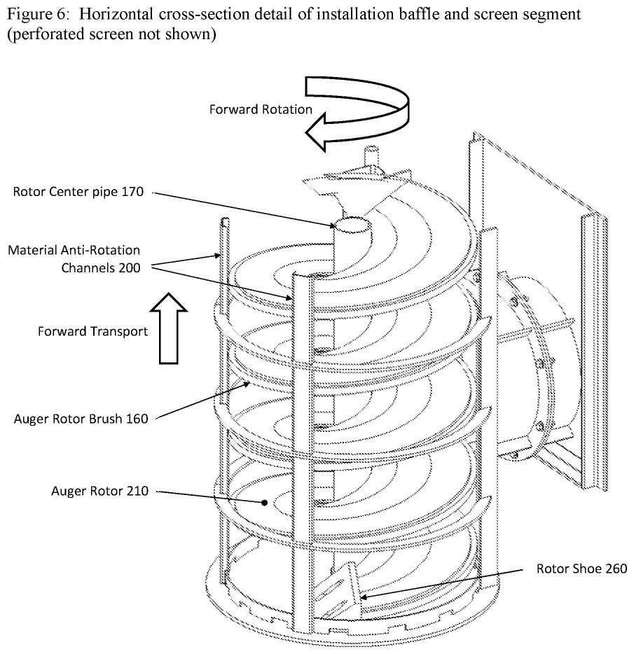

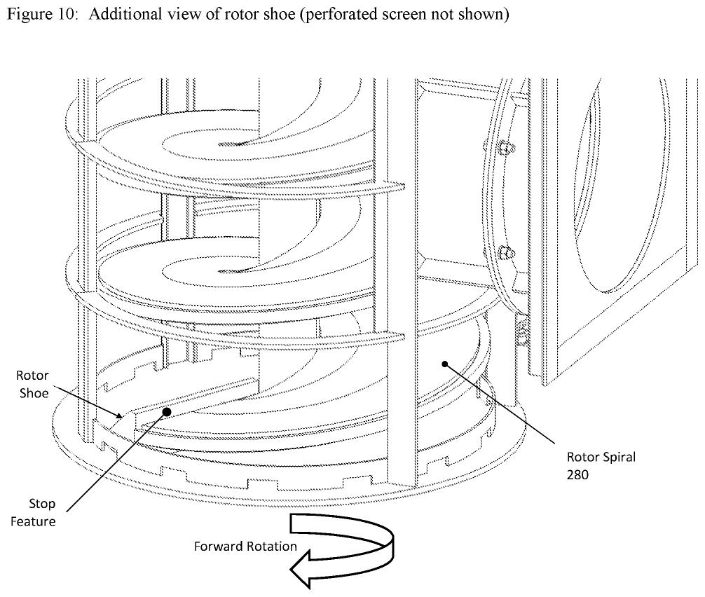

A lifting scraper, or rotor shoe 260 may be fastened to the leading-edge, relative to the forward direction of travel, of the tail end of the rotor spiral 280 of the auger rotor 210, (FIG. 6, 9, 10). The lifting scraper may have a triangular cross section and include an adjustment feature allowing the leading edge of the scraper to contact the top surface of the bottom plate 130 of the screen segment 50. A stop feature 270 on the lifting scraper may protrude above the top surface of the rotor spiral 280 of the rotor auger 210 (FIG. 10).

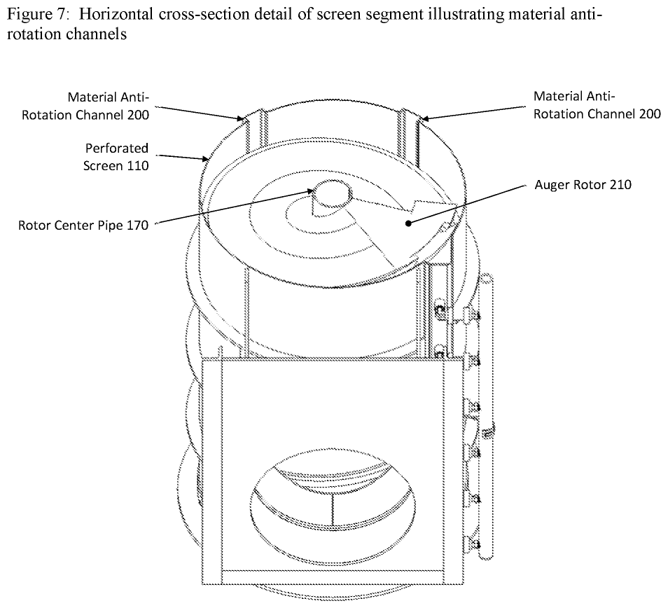

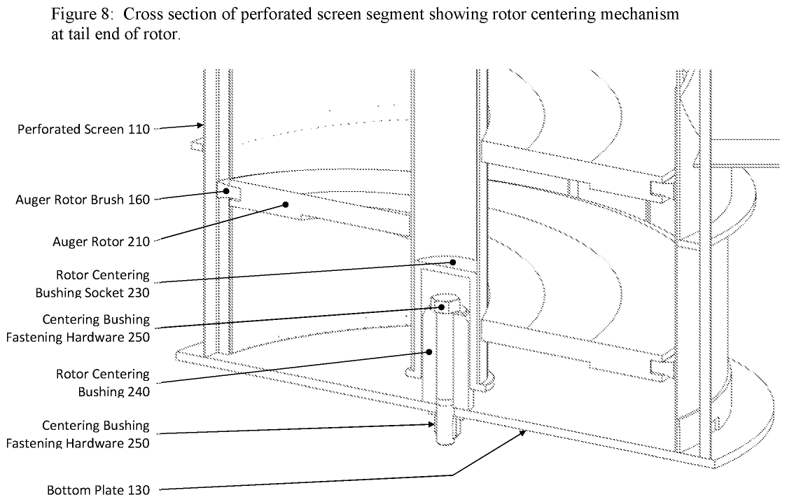

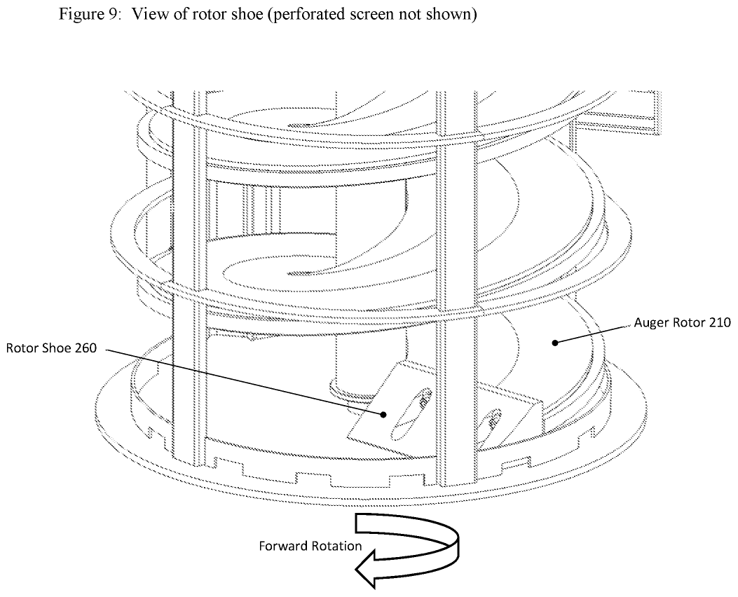

The screw conveyor may also include a rotor centering bushing feature 230, 240 (FIG. 8) and which may consist of: (i) a rotor centering bushing 240; (ii) a rotor centering bushing socket 230, and; (iii) centering bushing fastening hardware 250. The centering bushing socket 230 is fitted in the tail end of the rotor center pipe 170 that traverses the rotor down the center of the spiral (FIG. 7, 8). The centering bushing hardware 250 fastens the centering bushing 240 to the rotor side of the bottom plate 130 through a hole in the center of the plate. The centering bushing 240 protrudes into a pocket in the centering bushing socket 230 with reasonable minimum clearance between the outer cylindrical surface of the centering bushing 240 and the inner cylindrical surface of the centering bushing socket 230.

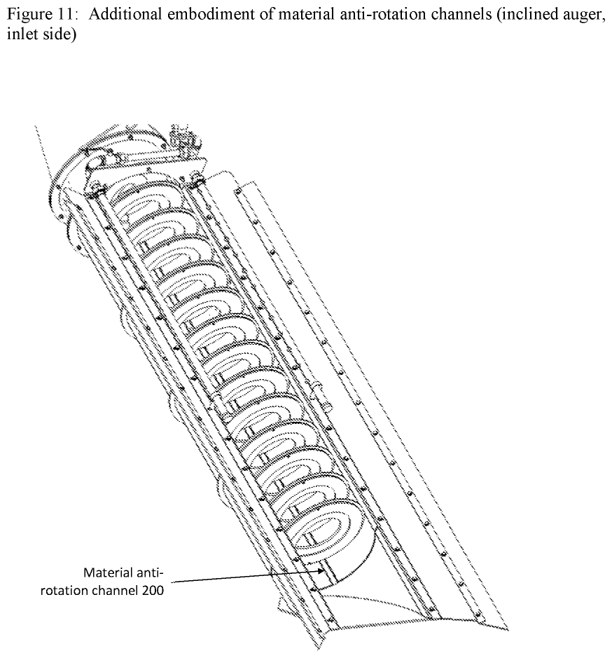

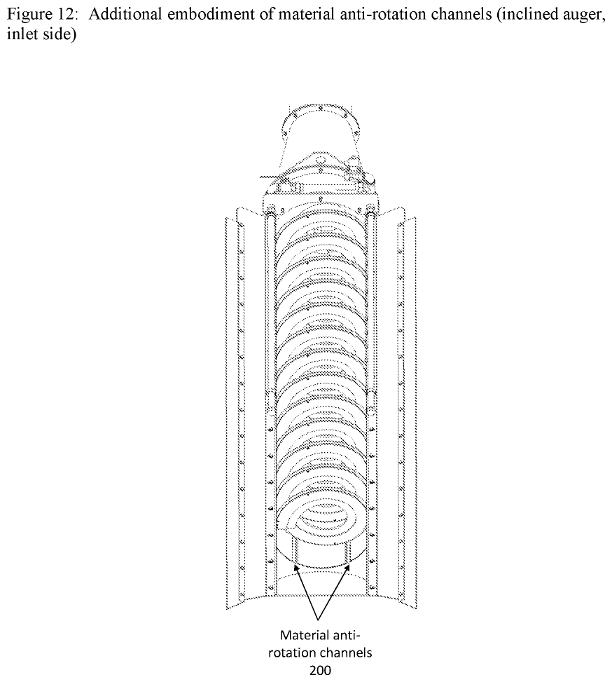

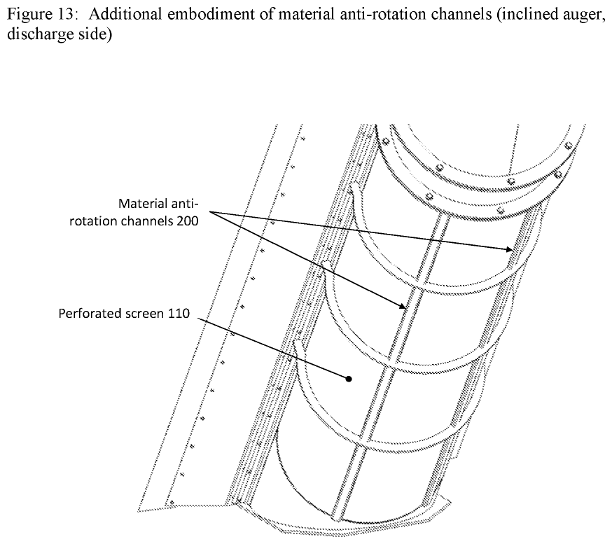

In another embodiment of the disclosure, the material anti-rotation channels may be included in the perforated screen trough of an inclined, screening screw conveyor (FIG. 11, 12, 13.)

1. A screw conveyor for discharging solids from a solid/liquid waste stream comprising:
a cylindrically shaped screen segment including perforated screen segments and an inlet for receiving a stream including solid and liquid materials, the perforated portions configured to permit liquids and smaller materials to pass therethrough;
a rotor auger disposed within the screen segment including helical flights configured to move solid materials larger than perforations on the perforated screen to move vertically when rotated;
a drive motor to rotate the rotor auger;
anti-rotation elements disposed radially outward between adjacent perforated screen segments configured to prevent rotation of solid materials to permit the rotor auger to move the solid materials in an axial direction of the rotor auger rotation.

2. The screw conveyor according to claim 1, wherein the anti-rotation elements are U-shaped channels open toward the rotor auger.

3. The screw conveyor according to claim 1, wherein innermost portions of the anti-rotation elements in the radial direction do not extend inward of the perforated screen segments.

4. The screw conveyor according to claim 1, further comprising a rotor shoe at a lowermost portion of the helical flights and at and end of the helical flights of the rotor auger that extends axially upward from the helical flights.

5. The screw conveyor according to claim 4, wherein the rotor shoe has a triangular cross section to taper at a thinnest portion on an edge opposite to where the rotor shoe is attached to the helical flights.

6. The screw conveyor according to claim 4, wherein the rotor shoe is adjustably attached to the end of the helical flights.

7. The screw conveyor according to claim 5, wherein a side of the rotor shoe attached to the end of the helical flights protrudes above an upper surface of the helical flights.

8. The screw conveyor according to claim 1, further comprising a center pipe that extends axially through the center of the rotor auger and forms an open portion within a lower most end of the center pipe;
a bottom plate attached to the bottom of the cylindrical shaped screen segment; and
a bushing configured to fit within the center pipe that is attached to the bottom plate.

9. The screw conveyor according to claim 1, wherein an axis of rotation of the rotor auger is inclined with respect to a gravity direction.

10. The screw conveyor according to claim 1, wherein an axis of rotation of the rotor auger extends vertically with respect to a gravity direction.

11. A screw conveyor system according to claim 1, further comprising a transport segment for receiving solid materials from the screen segment and extending vertically upward from the screen segment.
